(19) United States
(12) Patent Application Publication
(10) Pub. No.: US 2009/0150548 A1
(43) Pub. Date: Jun. 11, 2009

(54) Management of network-based services and servers within a server cluster

(75) Inventors: Geoffrey R. Smith, Mountain View, CA (US); Liam P. O'Gorman, Novato, CA (US); Mandar P. Deolalikar, Sunnyvale, WA (US); Dominic J. Angelini, San Jose, CA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/172,783

(22) Filed: Jul. 14, 2008

Related U.S. Application Data
(63) Continuation of application No. 11/939,498, filed on Nov. 13, 2007, now abandoned.

(51) Int. Cl. G06F 15/173

(52) U.S. Cl. 709/226

(57) ABSTRACT

Techniques are described to manage network-based services and servers within a server cluster. In an implementation, a plurality of sub-groups is formed of servers included in a server cluster. Network-based services are assigned to each of the sub-groups such that at least two of the sub-groups have matching deployments of the network-based services.

### RELATED APPLICATIONS

This application is a continuation of and claims priority to U.S. patent application Ser. No. 11/939,498, filed on Nov. 13, 2007, which is incorporated by reference herein.

### BACKGROUND

Server clusters are typically formed to provide a relatively large amount of computing resources for a variety of uses. For example, a server cluster may be formed to provide email functionality to millions of users, provide instant messaging between users, provide remote execution of modules for interaction by one or more users (e.g., games), and so on. As this variety of functionality and the numbers of users that desire access to this functionality continues to increase, so to does the size and complexity of server clusters used in support of this functionality.

A server cluster, for instance, may be configured to provide a wide variety of network-based services. However, this variety of network-based services may become so numerous such that any one of the servers in the server cluster is not able to provide each of the network-based services. Therefore, assignment of the network-based services is distributed across the servers such that each of the servers provides a subset of the network-based services. Thus, this assignment may be performed such that the servers of the server cluster collectively provide each of the desired network-based services without providing each of the network-based services by each of the servers. Previous techniques that were utilized to assign network-based services to the servers in the server cluster, however, were performed such that addition or removal of servers within the cluster resulted in reassignment of each of the network-based services in the server cluster, which resulted in interruptions in the provision of the network-based services to users. Likewise, changes to the network-based services themselves also caused service interruptions due to reassignment of the network-based services.

### SUMMARY

Techniques are described to manage network-based services and servers within a server cluster. In an implementation, a plurality of sub-groups is formed of servers included in a server cluster. Network-based services are assigned to each of the sub-groups such that at least two of the sub-groups have matching deployments of the network-based services.

In another implementation, a determination is made regarding a number of adjustments to be made to deployments of a plurality of network-based services in a server cluster. The adjustments are randomized and then iteratively made to servers in the server cluster based on respective loads of the servers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ techniques to manage network-based services and servers within a server cluster.

FIG. 2 illustrates an exemplary implementation of a service matrix of FIG. 1 showing assignment of network-based services to servers within a server cluster.

FIG. 3 is a flow diagram depicting a procedure in an exemplary implementation in which sub-groups of servers are formed in a server cluster to assign and manage network-based services.

FIG. 4 is a flow diagram depicting a procedure in an exemplary implementation in which network-based services are deployed in a server cluster using an iterative technique based at least in part on respective loads of the servers.

FIG. 5 is a flow diagram depicting a procedure in which adjustments are made to deployments of network-based services in a server cluster.

FIG. 6 is a flow diagram depicting a procedure in which network-based services are assigned due to a change in a number of servers included in a server cluster.

### DETAILED DESCRIPTION

Overview

As previously described, server clusters may be configured to provide a wide variety of network-based services (hereinafter referred to in the following discussion as “services” or “network-based services”), such as to provide content such as television programs, movies, radio programs, and so on. However, because of the wide variety of network-based services and amount of resources used to provide the services, each server in the server cluster may be configured to provide a subset of the total number of services.

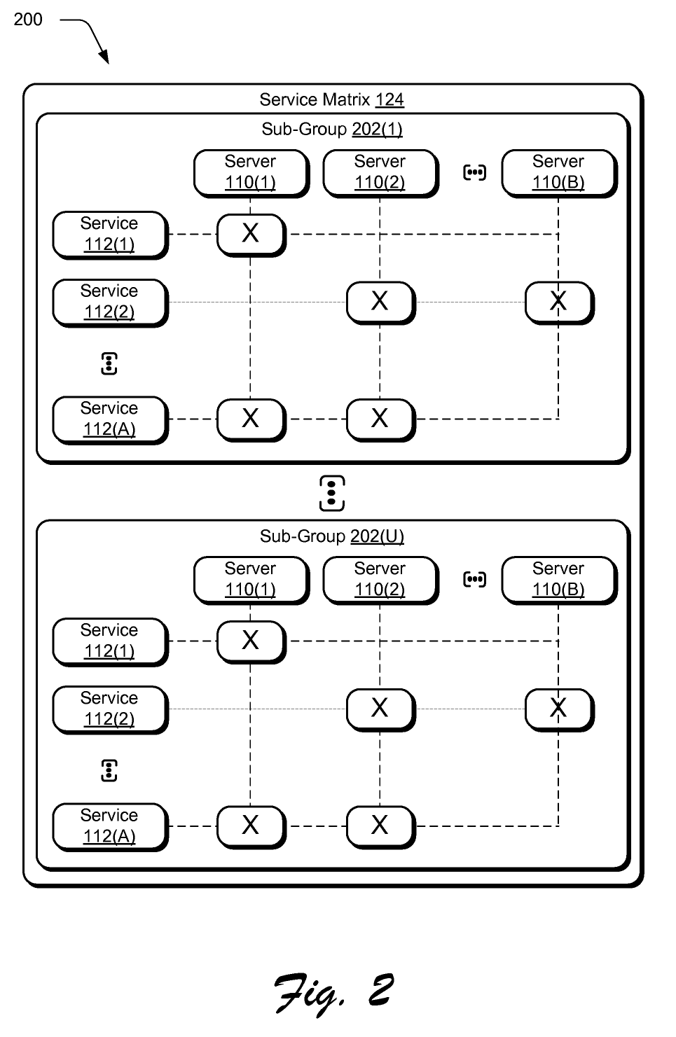

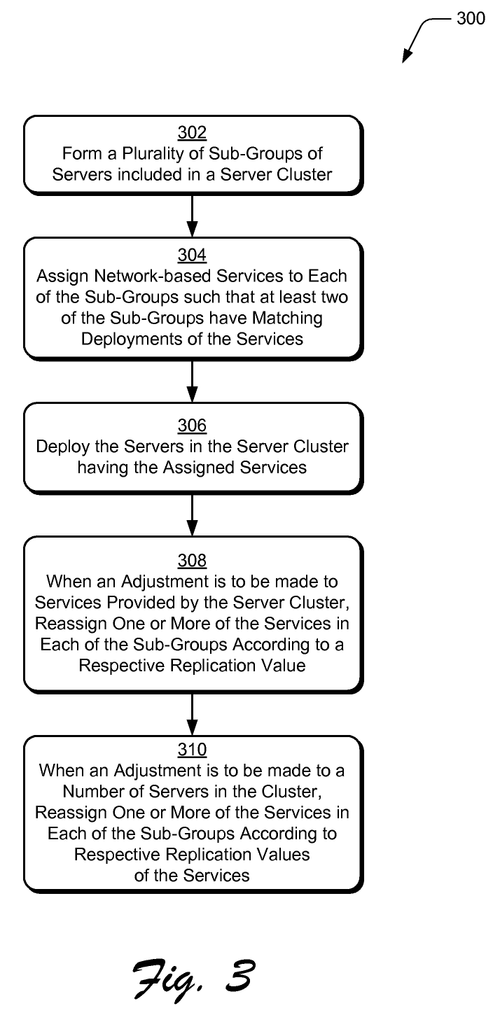

Accordingly, management techniques of servers and network-based services within a server cluster are described. One such technique, for example, involves dividing a server cluster into a plurality of sub-groups, each of which having matching network-based service assignments. The network-based services are assigned within the sub-groups according to a replication value which is used to determine a number of the servers in the server cluster that are to provide the network-based service, such as “X” percent of the servers. The replication values may be constrained such that integer values are obtained for each of the assignments within a sub-group, i.e., such that assignments are not made to “part” of a server. These sub-groups may be managed through use of a matrix. The matrix, for instance, may detail the network-based service/server combinations within an exemplary sub-group, which may then be “cloned” for each of the other sub-groups. In this instance, corresponding servers in the sub-groups are assigned corresponding network-based services. Through use of sub-groups, changes may be made to network-based services and/or servers of the server cluster without interrupting service to each of the network-based services and/or servers. Further discussion of sub-groups may be found in relation to FIGS. 2-3.

In another example, a technique involves an iterative strategy to assign network-based services to servers in the server cluster. This iterative strategy may be performed in a variety of ways. For instance, a determination may be made as to a number of changes regarding deployment of network-based services by the server cluster, such as due to a change in a number of servers, a change to which network-based services are provided by the server cluster, a change to a replication value of a respective network-based service, and so on. These changes to be made to the deployment of the network-based services may then be randomized and placed within an array. An ordered list of servers may also be generated based on load (e.g., amount of resources used by the server during a period of time) and the changes made using the ordered list and the randomized array.

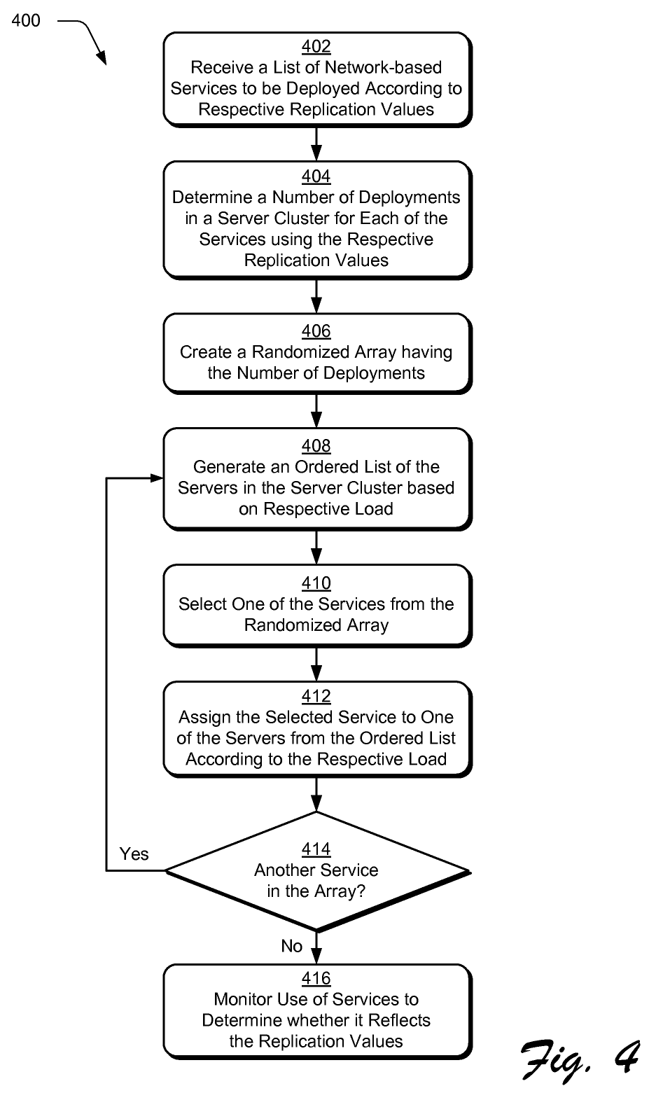

When network-based services are to be added to the server cluster, for example, a server having a relatively lower amount of load with respect to other servers in the cluster is first assigned a network-based service from the array. Likewise, when network-based services are to be removed from the server cluster, a server having a relatively higher amount of load with respect to other servers in the cluster that include the network-based service may first have the network-based service assignment removed. A variety of other examples are also contemplated such as regarding assignment of network-based services due to addition or removal of servers to the server cluster, further discussion of which may be found in relation to FIGS. 4-6.

In the following discussion, an exemplary environment is first described which is operable to employ techniques to manage network-based services and servers within a server cluster. Exemplary procedures are then described which may be performed in the exemplary environment, as well as in other environments.

Exemplary Environment

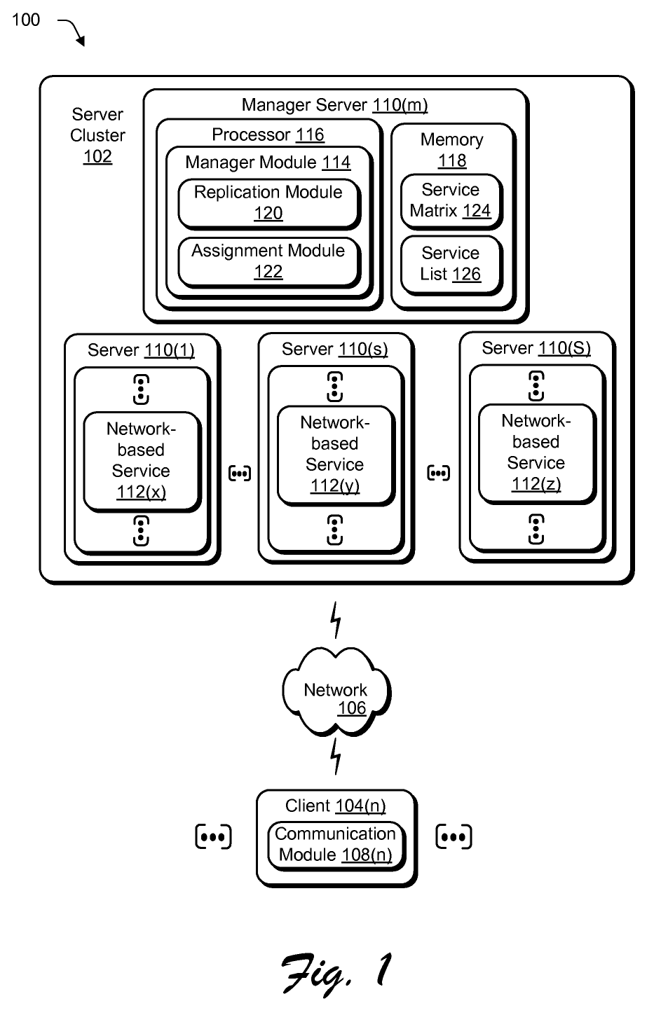

FIG. 1 is an illustration of an environment 100 in an exemplary implementation in which a server cluster 102 is communicatively coupled to one or more clients 104(n) (where “n” can be any integer from one to “N”) via a network 106. The clients 104(n) may be configured in a variety of ways. For example, one or more of the clients 104(1)-104(N) may be configured as a computer that is capable of communicating over a network 106, such as a desktop computer, a mobile station, an entertainment appliance, a game console, a set-top box communicatively coupled to a display device, a wireless phone, and so forth. The clients 104(n) may also relate to a person and/or entity that operate the client. In other words, clients 104(n) may describe logical clients that include software, a user and/or a machine. The network 106 is illustrated as the Internet, and may include a variety of other network, such as wide area networks (WANs), an intranet, a wired or wireless telephone network, a satellite network, a cable network, a digital subscriber line (DSL) network, a broadcast network with a backchannel to provide two-way communication, and so forth.

The server cluster 102, as illustrated, includes a plurality of servers 110(1), . . . , 110(s), . . . , 110(S) each having, respectively, a sub-group of network-based services 110(x), 110(y), 110(z) (where “x”, “y” and “z” can be any integer from one to “X”, “Y” and “Z”, respectively) to be provided by the server cluster 102. In the following discussion, network-based services provided by the server cluster 102 may be referred to collectively as “network-based services 110”. Network-based services 110 may be configured in a variety of ways, such as to extend the functionality of the Internet by providing a basis for software to connect to other software applications, provide content over a network (e.g., streaming of video), and so on. Network-based services 110 typically provide functionality in a way that may be used by a diverse range of devices, using different networks and protocols, to provide various functions. A network-based service typically provides a specific element of functionality to service a specific request, such as online streaming of content that is buffered, streaming of subsets of relatively large data files, and so on. For purposes of brevity in the following discussion and figures, network-based services may also be referred to as “services”.

Network-based services 110, for instance, provide application logic that is programmatically available. In this instance, the network-based services 110 may be called by the communication module 108(n), which may then receive data in a format that is accessible for processing by the communication module 108(n). By providing application logic that is programmatically available, network-based services 110 may be accessed in a variety of ways. A service, for instance, may be accessed by an application implemented internally within a computer, by a computer over an intranet, by a computer over the Internet, and the like. Additionally, a network-based service may use open Internet standards so that it may be accessed by a wide range of clients 104(n) in a seamless manner. For instance, an application running locally on a user's computer may access the service using open Internet standards directly.

In an example, the network-based services are configured to provide a variety of television services. Service 110(x), for example, may be configured to provide network digital video recorder (NDVR) services, video-on-demand (VOD) services, pay-per-view (PPV) services, electronic programming guide (EPG) services, enhanced programming, television program searching, and other television services, such as digital rights management (DRM), t-commerce (i.e., “television” commerce), and so on. In such an example, the server cluster 102 may be configured as a Multiple System Operator (MSO) although a variety of other examples are also contemplated, such as through configuration as an Internet service provider (ISP), email provider, and so on.

The server cluster 102 is further illustrated in FIG. 1 as including a manager server 110(m) having a manager module 114 that is executable on a processor 116 and storable in memory 118. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 118 is shown, a wide variety of types and combinations of memory may be employed, such as random access memory (RAM), hard disk memory, removable medium memory, and so forth.

Although the manager server 110(m) of FIG. 1 is illustrated as a single server, functionality represented by the manager server 110(m) and the manager module 114 may be provided through use of a plurality of servers. Additionally, although the manager server 110(m) is illustrated as separate from the other servers 110(1)-114(S) that provide network-based services 112 for sake of clarity in the discussion, the manager server 110(m) may also provide network-based services as previously described and therefore also function to provide network-based services.

The manager module 114 is representative of functionality to mange network-based services and servers within the server cluster 102. As illustrated, the manager module 114 further includes a replication module 120 and an assignment module 122. The replication module 120 is representative of functionality to decide replication values of network-based services 116 deployed by the servers 110(1)-110(S) in the server cluster 102, e.g., a number of servers that are to provide a corresponding network-based service. The assignment module 122 is representative of functionality that assigns the network-based services 112 to particular servers. In this way, the functionality to decide saturation of the network-based services within the server cluster 102 may be separated from the functionality to assign the network-based services within the server cluster 102, which may be used to efficiently make changes to the techniques employed by each.

The server cluster, for example, may include ten servers and the replication values of first and second network-based services may be expressed as proportions, e.g., 0.3 and 0.5. Therefore, in this example the replication module 120, when executed, determines that the first network-based service is to be provided by three servers in the server cluster 102 and the second network-based service is to be provided by half (e.g., five) of the servers in the server cluster 102. In this way, different “saturations” of the network-based services 112 may be specified for a variety of different considerations, such as based on anticipated and/or monitored usage of the network-based services 112, amount of resources consumed by the servers in providing the network-based services, and so on.

The assignment module 122 may then be executed to determine which of the servers 110(1)-110(S) are to include the network-based services. The assignment module 122, for example, may determine a relative load (e.g., amount of resources utilized) of one or more of the servers 110(1)-110(S) in the server cluster 102 to provide corresponding network-based services. The assignment module 122 may then use this information to assign the network-based services 116 to particular servers, such as to efficiently distribute the load across the servers 110(1)-110(S).

The assignment module 122, for instance, may use an iterative technique to add and/or remove deployments of network-based services 116 from particular servers. When adding network-based services, for instance, servers which have a relatively lower amount of load when compared to other servers in the server cluster may receive the assignments. The computation of the load of the servers may be iteratively performed before each of the assignments to ensure that the effect of the assignment is taken into account. A similar technique may be used when removing network-based services, in which, servers which provide the network-based service are ordered according to load and servers with a relatively higher degree of load have the network-based service removed first. These techniques may also be used for a variety of reasons. For example, theses techniques may be performed when adjusting replication values for one or more of the network-based services 116 provided by the server cluster and also to account for addition and/or removal of servers 110(1)-110(S) from the server cluster 102, further discussion of which may be found in relation to FIGS. 4-6.

The manager module 114 may also use a variety of techniques to track which network-based services are provided by which servers 110(1)-110(S) and therefore account for previous configurations of the server cluster 102 when changes are to be made. For example, the manager server 110(m) may use a service matrix 124 to determine a current configuration of the server cluster, i.e., which network-based services are provided by which servers, and from this, determine which changes are to be made when a network-based service and/or server is added or removed. In this way, the changes to the configuration may be minimized by taking into account a current configuration of the server cluster 102, thereby decreasing and even eliminating interruptions to the services that were encountered using traditional techniques.

Additionally, the manager module 114 may use a service list 126 to manage the network-based services 112(x)-112(z). The service list 126, for instance, may detail services with associated replication values which are used to determine a number of the servers in the server cluster that are to provide the network-based service, such as “X” percent of the servers. The replication values may also be managed by the manager module 114 such that “saturation” of the service within the server cluster 102 may be increased or decreased. Further discussion of the service matrix 124 and the service list 126 may be found in relation to the following figures.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware or a combination thereof. In the case of a software implementation, the module, functionality, or logic represents program code that performs specified tasks when executed on a processor (e.g., CPU or CPUs such as the processor 116). The program code can be stored in one or more computer readable memory devices, e.g., the memory 118. The features of the management strategies described below are platform-independent, meaning that the strategies may be implemented on a variety of commercial computing platforms having a variety of processors.

FIG. 2 illustrates an exemplary implementation of the service matrix 124 of FIG. 1 depicting assignment of network-based services to servers within a server cluster. The service matrix 124 is illustrated as being broken into a plurality of sub-groups 202(1)-202(U) referencing assignment of network-based services 112(1)-112(A) to corresponding servers 110(1)-110(B) of the server cluster 102. In the illustrated implementation, each of the sub-groups 202(1)-202(U) has matching assignments to respective servers. Therefore, the sub-group 202(1)-202(U) may be considered as cloned through the server cluster 102 in the assignment of network-based services to particular servers. When groups of servers are added in a number that corresponds to the number of servers in the sub-group, for instance, the sub-group may be cloned using the new servers, thereby preserving replication values of network-based services deployed in the server cluster 102.

“Excess” servers that are not included in the sub-groups may be treated in a variety of ways. For example, the servers may be successively added to the server cluster 102 in a manner that mimics the sub-group, such that, when a number of servers is eventually added that corresponds to the number of servers in the sub-group, the replication values of the network-based services is preserved without reassigning the network-based services. In another instance, the network-based servers may be assigned to the servers individually to preserve the replication values of the server cluster 102 as a whole as the servers are added. A wide variety of other examples are also contemplated. In an implementation, the replication values are constrained to result in assignment to integer number of servers, thereby avoiding rounding errors. Network-based services may be assigned to the servers in a variety of ways, further discussion of which may be found in relation to the following procedures.

Exemplary Procedures

The following discussion describes management techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

FIG. 3 depicts a procedure 300 in an exemplary implementation in which sub-groups of servers are formed in a server cluster to assign and manage network-based services. A plurality of sub-groups of servers is formed for servers in a server cluster (block 302). For example, a technician may make a determination of sub-group size based on a number of servers within a server cluster, a number of network-based services to be offered in the server cluster and/or replication values that are going to be used to assign network-based services within the cluster. This determination, for instance, may be made to arrive at generally integer values of servers when assigning network-based services based on the replication value of respective network-based services. In another example, this determination may be performed automatically by the manager module 114. A variety of other examples are also contemplated.

Network-based services are assigned to each of the sub-groups such that at least two of the sub-groups have matching deployments of the network-based services (block 304). For example, as shown in FIG. 2, each of the servers in sub-group 202(1) has a corresponding server in sub-group 202(U) the provides the same network-based services. The servers are then deployed in the server cluster having the assigned network-based services (block 306). Service/server combinations may be tracked through use of a service matrix 124.

When an adjustment is to be made to the network-based services provided by the server cluster, one or more of the network-based services are reassigned according to a respective replication value (block 308). For example, network-based services may be added and/or removed from the server cluster, the addition of which may be performed based on the replication value for the services. Likewise, when an adjustment is to be made to a number of servers in the server cluster, one or more of the network-based services are reassigned according to a respective replication value (block 310). These assignments may be performed in a variety of ways, such as through use of the service matrix 124 to determine a minimum amount of changes that would result in implementation of the replication values, iterative techniques as described in relation to the following figures, and so on.

FIG. 4 depicts a procedure 400 in an exemplary implementation in which network-based services are deployed in a server cluster using an iterative technique based at least in part on respective loads of the servers. A list of network-based services is received which are to be deployed according to respective replication values (block 402). For example, the list may indicate that first and second network-based services are to be deployed having respective replication values of 0.4 and 0.3.

A number of deployments in the server cluster is then determined for each of the network-based services using the respective replication values (block 404). Continuing with the previous example, the manager module 114 may determine that the server cluster includes ten servers and therefore the first network-based service should be deployed on four of the servers and the second network-based service should be deployed on three servers based on their respective replication values.

A randomized array is then created having the number of deployments (block 406). The manager module 114, for instance, may place references to the network-based services in an array using a variety of randomization techniques.

An ordered list of the servers in the server cluster is generated based on respective load (block 408). For example, the servers may be ordered in the list based on respective loads in relation to each other, such as from a relatively low amount of load successively to a relatively high amount of load. Additionally, servers already having the network-based service may be excluded from the ordered list.

One of the network-based services is selected from the randomized array (block 410). The selected network-based service is then assigned to one of the servers from the ordered list according to the respective load (block 412), such as to assign the network-based service to the server having the relatively “least” amount of load in relation to the other servers in the array. In an implementation, when two or more servers have the same amount of load, one of the servers may be randomly chosen.

A determination is then made as to whether another network-based service is referenced in the array (decision block 414). If so (“yes” from decision block 414), a portion of the procedure may be repeated (blocks 408-412) for the other network-based service. Thus, multiple iterations of this portion of the procedure may be performed to successively assign network-based services to servers in the server cluster.

When there is not another network-based service in the array (“no” from decision block 414), use of the network-based services may be monitored to determine whether the use reflects the replication values (block 416). For example, the manager module 114 may determine whether use of the network-based services corresponds to the amount of resources allocated (e.g., number of servers) to the network-based service. If not, the replication value may be changed and that change promulgated to the server cluster, further discussion of which may be found in relation to the following figure.

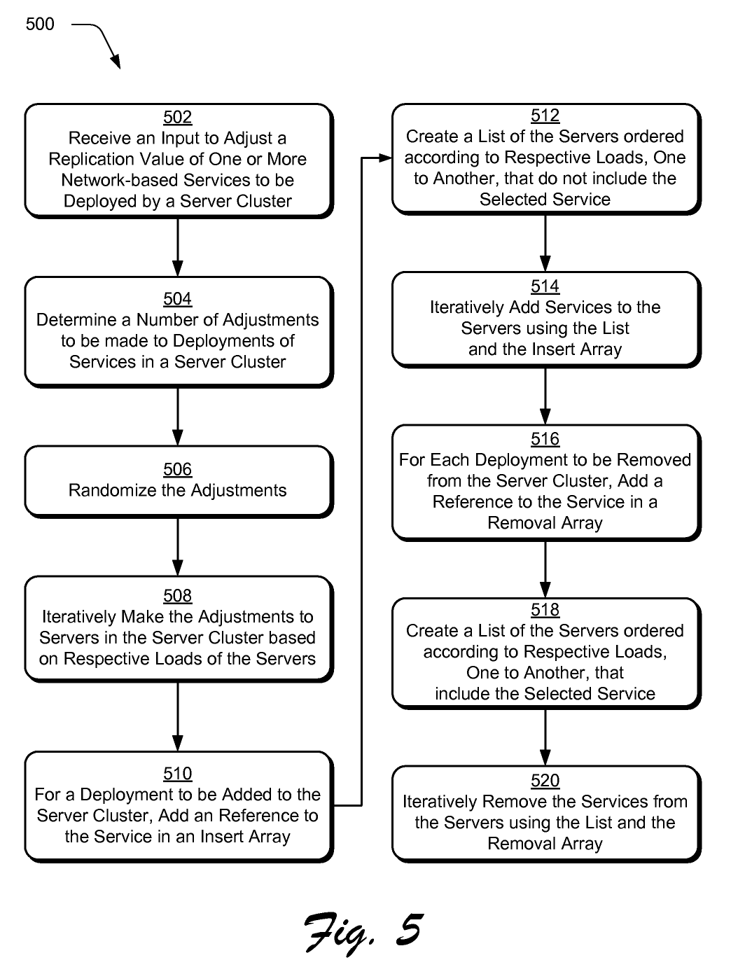

FIG. 5 depicts a procedure 500 in an exemplary implementation in which adjustments are made to deployments of network-based services in a server cluster. An input is received to adjust a replication value of one or more network-based services to be deployed by a server cluster (block 502). For example, a technician may determine that replication values of one or more network-based services should be changed to reflect anticipated changes in use of the network-based services, such as to support an updated service during initial release. In another example, the input may be received through monitoring performed by the manager module itself as described in relation to the previous figure. A variety of other examples are also contemplated.

A determination is made as to a number of adjustments that are to be made to deployments of network-based services in a server cluster (block 504). For example, a replication value may be increased and therefore the number may reflect this increase to implement the replication value. Likewise, a replication value may be decreased. Further, network-based services may be added to or removed from the server cluster also using similar techniques.

The adjustments are then randomized (block 506), such as through randomization in an array. The adjustments are then iteratively made to servers in the server cluster based on respective loads of the servers (block 508).

For each deployment to be added to the server cluster, for example, a reference to the network-based service is added to an insert array (block 510). A list of the servers that do not include the network-based service is created that is ordered according to respective loads (block 512). The network-based service is iteratively added to the servers using the list and the insert array (block 514). As previously described in relation to FIG. 4, for instance, network-based services may be selected from the array and assigned to servers (based on the list) which have a relatively lower load than other servers in the server cluster.

For each deployment to be removed to the server cluster, a reference to the network-based service is added to a removal array (block 516). A list of the servers that do include the network-based service is created that is ordered according to respective loads (block 518). The network-based service is iteratively removed from the servers using the list and the insert array (block 520). As before, the network-based services may be selected from the array and removed from the servers which have a relatively higher load than other servers in the server cluster. In this way, changes to the deployment of network-based services may be minimized thereby decreasing the likelihood of service interruptions. In an implementation, additions of network-based service deployments are performed before removals to increase likelihood of service availability.

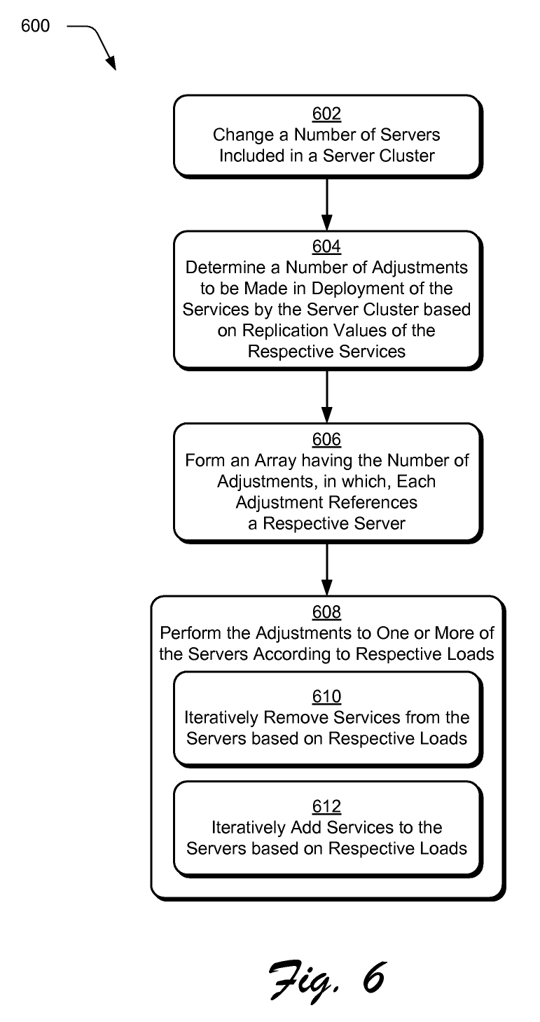

FIG. 6 depicts a procedure 600 in an exemplary implementation in which network-based services are assigned due to a change in a number of servers included in a server cluster. A change is to be made to a number of servers included in a server cluster (block 602), such as to add a server, remove a server, due to server inoperability, and so on.

A determination is made as to a number of adjustments to be made in deployment of network-based services by the server cluster based on replication values of the respective network-based services (block 604). For example, the manager module 114 may determine that one of the servers is no longer available (e.g., due to software, hardware and/or network error) and determine which changes, if any, should be made to deployment of the network-based services based on the unavailability. In another example, a server may be added or removed which may also affect the deployment of the network-based services by the cluster.

An array is formed having the number of adjustments (block 606) to be made to the deployment. The adjustments are then performed to one or more of the servers according to respective loads (block 608). For example, network-based services may be iteratively removed from (block 610) or added to (block 612) servers based on respective loads. Although an iterative technique has been described to add and remove network-based services, a variety of other techniques may also be performed when adding or removing servers to the server cluster.

As previously described in relation to FIG. 2, for instance, the servers may leverage the service matrix 124 to determine which services are to be provided by the server. A server that replaces another server, for instance, may be assigned the same network-based services as indicated by the service matrix 124. A variety of other implementations are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
forming a plurality of sub-groups of servers included in a server cluster; and
assigning network-based services to each of the sub-groups such that at least two of the sub-groups have matching deployments of the network-based services.

2. A method as described in claim 1, wherein:
at least two of the sub-groups have matching deployments, one to another, according to replication values for respective said network-based services; and
the replication values are used to determine a respective number of the servers in the server cluster that are to include a respective said network-based service.

3. A method as described in claim 1, wherein the network-based services are assigned by:
determining a number of deployments of network-based services in the service cluster for each of the network-based services using respective replication values, wherein the replication values are used to determine a respective number of the servers in the server cluster that are to include a respective said network-based service;
creating a randomized array that references each of the determined deployments of the network-based services;
generating an ordered list of the servers based on respective load, one to another; and
iteratively assigning the network-based services to the server using the randomized array and the ordered list.

4. A method as described in claim 3, wherein the network-based services are iteratively assigned by generating the ordered list of the servers before each said assignment of the network-based services.

5. A method as described in claim 1, wherein the network-based services are assigned such that the servers are not assigned a plurality of deployments of a particular said network-based service.

6. A method as described in claim 1, further comprising when an adjustment is to be made to network-based services provided by the server cluster, reassigning one or more of the network-based services in each of the sub-groups according to a respective replication value.

7. A method as described in claim 1, further comprising when an adjustment is to be made to a number of servers in the server cluster, reassigning one or more of the network-based services in each of the sub-groups according to a respective replication value.

8. A method as described in claim 1, further comprising:
monitoring use of the network-based services; and
adjusting at least one replication value based on the monitoring.

9. A method as described in claim 1, wherein at least one said network-based service is configured to stream content over a network to one or more clients.

10. A method as described in claim 1, wherein one or more said network-based services are selected from the group consisting of:
a television program service;
a streamed audio service;
a streamed radio service;
a streamed video service;
a video-on-demand (VOD) service;
a pay-per-view (PPV) service;
a network digital video recorder (NDVR) service;
an enhanced television programming service;
an enhanced streamed video service; and
an enhanced streamed audio service;

11. A method comprising:
determining a number of adjustments to be made to deployments of a plurality of network-based services in a server cluster;
randomizing the adjustments; and
iteratively making the randomized adjustments to servers in the server cluster based on respective loads of the servers.

12. A method as described in claim 11, wherein:
the number of adjustments are made in response to a change to a replication value of at least one of the network-based services; and
the replication value is used to determine a number of the servers in the server cluster that are to include the at least one network-based service.

13. A method as described in claim 11, wherein the adjustments are made iteratively such that the respective loads of the servers are computed before each said adjustment is made.

14. A method as described in claim 13, wherein when two or more said servers having matching said loads, the adjustments are iteratively made to the two or more said servers randomly.

15. A method as described in claim 11, wherein when the number of adjustments is made to add one or more deployments of network-based services to the server cluster, the adjustments are made to the servers in order of respective said loads, from low to high.

16. A method as described in claim 11, wherein when the number of adjustments is made to remove one or more deployments of network-based services from the server cluster, the adjustments are made to the servers in order of respective said loads, from high to low.

17. One or more computer-readable media comprising computer executable instructions that are executable to direct a computer to:
determine a number of adjustments to be made to deployments of network-based services by a server cluster based on replication values of the respective network-based services when a number of servers included in the server cluster is changed; and
perform the adjustments to one or more of the servers according to respective loads.

18. One or more computer-readable media as described in claim 17, wherein the number of adjustments is performed iteratively such that the respective loads are computed before each said adjustment is performed.

19. One or more computer-readable media as described in claim 17, wherein the replication values are used to determine a number of said servers that are to include a respective said network-based service.

20. One or more computer-readable media as described in claim 17, wherein the adjustments include iteratively removing network-based services from one or more of the servers in the server cluster and iteratively adding network-based services to one or more of the servers in the server cluster.
